(19) United States
(12) Patent Application Publication
(10) Pub. No.: US 2010/0071490 A1
(43) Pub. Date: Mar. 25, 2010

(54) TELESCOPIC ACTUATOR WITH A MAIN ROD AND AN AUXILIARY ROD

(75) Inventors: Hervé CHARUEL, NOZAY (FR); Daniel BUCHETON, LE CHESNAY (FR); Florent NIERLICH, COURBEVOIE (FR)

Correspondence Address: SUGHRUE MION, PLLC, 2100 PENNSYLVANIA AVENUE, N.W., SUITE 800, WASHINGTON, DC, 20037, US

(73) Assignee: MESSIER-BUGATTI, VELIZY VILLACOUBLAY (FR)

(21) Appl. No.: 12/566,307

(22) Filed: Sep. 24, 2009

(30) Foreign Application Priority Data
Sep. 25, 2008 (FR) FR 08 05272

(51) Int. Cl. F16H 25/20

(52) U.S. Cl. 74/89.35

(57) ABSTRACT

The present invention relates to a telescopic actuator comprising a cylinder 1 receiving a main rod 2 to slide along a sliding axis X between a retracted position and an extended position, the actuator further including an auxiliary rod 20 slidable in the main rod 2 between a retracted position and an extended position, and a rotary bearing 102 carried by the main rod 2 or the auxiliary rod 20 and co-operating respectively with the auxiliary rod 20 or the main rod 2 via a reversible helical connection. According to the invention, the actuator includes retaining means 112 for retaining the sliding of the auxiliary rod 20 and comprising a blocking member 116 arranged to act directly on the rotary bearing so as to cause rotation of the rotary bearing 102 to be blocked or to be released, blocking rotation of the rotary bearing 102 preventing the auxiliary rod 20 from moving in the main rod 2.

The invention relates to a telescopic actuator with a main rod and an auxiliary rod. More precisely, the invention relates to controlling the extension and the program of the auxiliary rod from the cylinder of the actuator.

### BACKGROUND OF THE INVENTION

A telescopic actuator is known that comprises a main rod and an auxiliary rod, the actuator essentially comprising a cylinder, slide means between the cylinder and the main rod, and slide means between the main rod and the auxiliary rod, thereby enabling the rods to slide between retracted and extended positions.

The actuator also includes retaining means enabling the auxiliary rod to be blocked or released in the main rod, and brake means for braking said auxiliary rod while it is being extended. An example of this type of embodiment is described in particular in document FR 2 895 483 A1.

This type of actuator is particularly advantageous since, in the event of the main rod becoming blocked, it makes it possible to continue lengthening the actuator by causing the auxiliary rod to be released by the retaining means, thereby unblocking the movement of the mechanical system in which it is included.

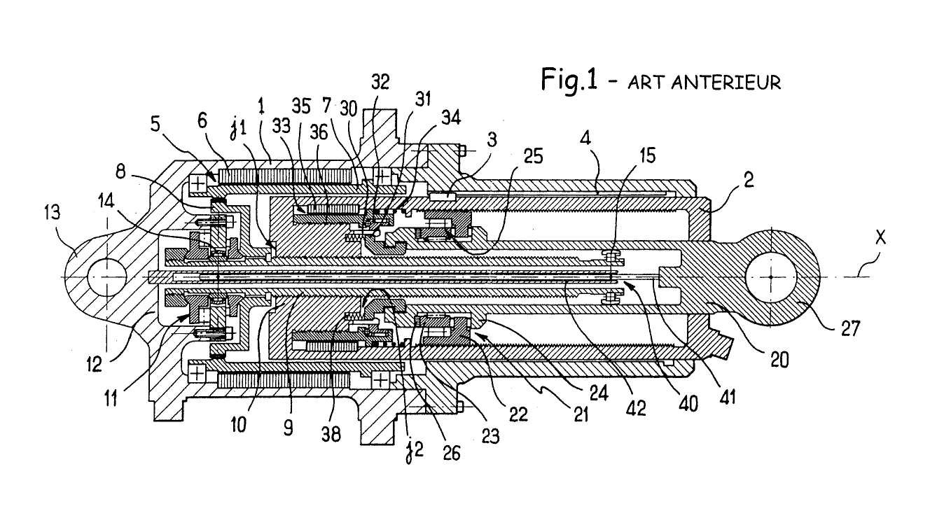

With reference to FIG. 1, there can be seen a diagrammatic section of an actuator of the state of the art as illustrated in the above-mentioned document, and it can be seen that it comprises a cylinder 1 defining a cylindrical cavity closed by an end wall 12 that carries a lug 13. A main rod 2 is mounted in the cavity of the cylinder 1 to slide along a sliding axis X, and it projects to a greater or lesser extent from the cylinder 1 through an open end of the cavity that forms a bearing.

The main rod 2 is hollow and defines a cavity in which an auxiliary rod 20 is mounted to slide inside the main rod 2 along the axis X and to project through an open end thereof that forms a bearing.

The actuator further includes controlled retaining means for retaining the auxiliary rod 20 in its retracted position inside the main rod 2. These retaining means comprise:
a catch 30 extending inside the main rod 2;
a step 31 provided at the end of the auxiliary rod 20 and adapted to co-operate with the catch 30; and
a locking sleeve 32 that is axially movable by an unlocking motor 33 against a return spring 34 between a locking position (shown in this figure) in which it covers the catch 30 so as to prevent it from expanding radially, and a release position in which it leaves the catch 30 free to expand radially when the step 31 passes therethrough. For this purpose, the unlocking motor 33 comprises a stator 35 secured to the main rod 2, and a rotor 36 that co-operates with a complementary thread of the main rod 2 to constitute a reversible helical connection. Rotation of the rotor 36 thus causes it to move axially. The locking sleeve 32 is carried at the end of the rotor 36 and is mounted thereto by means of rollers so as to be free to rotate.

The actuator further includes brake means for braking sliding of the auxiliary rod 20 in the main rod 2 in the direction for extending the auxiliary rod 20.

These brake means, which also form a bearing 21 for guiding the auxiliary rod 20 in the main rod 2, comprise:
an externally threaded driver 22 that co-operates with internal tapping of the main rod 2 so as to constitute a reversible helical connection between the driver 22 and the main rod 2;
a bushing 23 mounted to rotate on the auxiliary rod 20 by means of rollers, the driver 22 itself being mounted to rotate on the bushing 23 by means of rollers, the driver 22 being held captive axially between the bushing 23, and the rollers bearing against an abutment 24 of the auxiliary rod 20;
a ratchet-type freewheel 25 that is arranged between the diver 22 and the bushing 23 that causes the bushing 23 to rotate, when the auxiliary rod 20 is extended from the main rod 2 and the driver 22 turns because of the helical connection with the main rod 2. In contrast, when the auxiliary rod 20 returns into the main rod 2, the driver 22 turns but does not drive the bushing 23 in rotation; and
a friction washer 26 carried by the auxiliary rod 20 facing a free face of the bushing 23 and adapted to generate friction against the bushing 23 when it turns by being pressed against the friction washer 26 under external drive pulling on the auxiliary rod 20.

### OBJECT OF THE INVENTION

An object of the invention is to propose a telescopic type actuator having main and secondary rods in which the control and the braking of the auxiliary rod are both simplified and improved.

### BRIEF SUMMARY OF THE INVENTION

To this end, the present invention relates to a telescopic actuator comprising a cylinder receiving a main rod to slide along a sliding axis between a retracted position and an extended position, the actuator further including an auxiliary rod slidable in the main rod between a retracted position and an extended position, and a rotary bearing carried by the main rod or the auxiliary rod and co-operating respectively with the auxiliary rod or the main rod via a reversible helical connection such that sliding of the auxiliary rod causes the rotary bearing to rotate.

According to the invention, the actuator includes retaining means for retaining the sliding of the auxiliary rod and comprising a blocking member arranged to act directly on the rotary bearing so as to cause rotation of the rotary bearing to be blocked or to be released, blocking rotation of the rotary bearing preventing the auxiliary rod from moving in the main rod.

Thus, the actuator is considerably simplified compared with the state of the art. This characteristic makes it possible to reduce the weight of the actuator and to reduce its cost price since, in particular, the blocking and the release of the auxiliary rod by the blocking member do not require the use of a special motor.

According to an advantageous characteristic of the invention, the retaining means also include passive type brake means adapted to brake rotation of the rotary bearing when the auxiliary rod is sliding, the retaining means thus serving to perform functions both of controlling and of braking the extension of the auxiliary rod.

### BRIEF DESCRIPTION OF THE FIGURES

Other characteristics of the invention appear clearly on reading the following description of an embodiment given by way of non-limiting example.

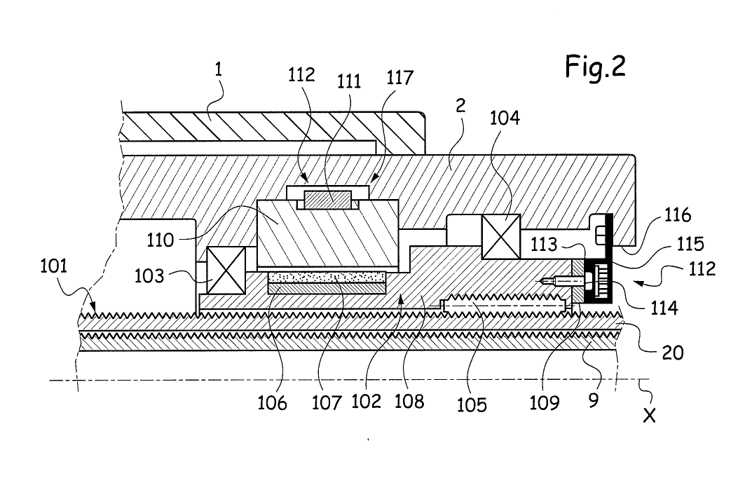

Reference is made to the accompanying figures in which, in addition to above-described FIG. 1, there is a FIG. 2 in the form of a fragmentary diagrammatic half-section view showing an embodiment of the actuator in accordance with the invention.

### DETAILED DESCRIPTION OF THE INVENTION

To facilitate reading and understanding FIG. 2 that shows an embodiment of the invention, references for elements that are common to FIGS. 1 and 2 are conserved unchanged. Thus, the actuator of FIG. 2 still comprises a cylinder 1, and main and auxiliary rods 2 and 20, these main and auxiliary rods 2 and 20 being mounted to slide respectively in the cylinder 1 and in the main rod 2 along the same sliding axis.

A first difference between the actuator of the invention and the prior art actuator lies in how the auxiliary rod 20 is controlled and braked, with the retaining means in the invention serving to block the auxiliary rod 20 in the retracted position by preventing the rotary bearing from rotating.

In the invention, the auxiliary rod 20 includes a thread 101 on its outside surface. The main rod 20 receives a bearing 102 that is mounted to rotate on the main rod 2 by rolling means 103 and 104. The rotary bearing 102 is connected to the auxiliary rod 20 via a reversible helical connection by means of threaded satellite rollers 105 extending between the auxiliary rod 20 and the rotary bearing 102 so that extending the auxiliary rod 20 causes the rotary bearing 102 to rotate. Sliding retaining means 112 act on the rotary bearing 102 either to block the auxiliary rod 20 via a blocking member 116, or to brake it via brake means 117.

Advantageously, the blocking member 116 is constituted by a brake. By an electromagnetic brake with a moving armature 113 mechanically connected to the nut body 114 and a stationary yoke 115 carrying a coil, the yoke 115 being connected to the cylinder 1 and prevented from moving axially or in rotation relative to the auxiliary rod 20. In the embodiment of FIG. 2, when the brake 116 is active, the electromagnetic interaction between the yoke 115 and the armature 113 prevents the nut body 114 from rotating.

Conversely, when the brake 116 is deactivated, the nut body 114 is free to turn and enables the bearing 102 to rotate, thereby releasing the auxiliary rod 20. The blocking member 116 thus acts directly on the element (the rotary bearing) that is in helical connection with the auxiliary rod 20.

Various technologies can be used for making the brake member 116, in particular it may comprise an electromagnetic brake 116 that brakes when drawing electricity or indeed when not drawing electricity, and/or a single- or multi-disk brake, or indeed a positive blocking member such as a jaw clutch or a gear clutch.

The brake means 117 and the auxiliary rod 20 are advantageously of the passive type, and they act on the rotary bearing 102 to brake rotation thereof. More precisely, the brake means 117 comprise:
a rotor 106 placed on the rotary bearing 102 to rotate together therewith. The rotor 106 is here made of hard iron and receives permanent magnets 107 that are disposed at the periphery of the rotor 106. In a variant, the rotor 106 could be made of magnetic steel. It should be observed that the rotary bearing 102 is made up of two portions 108 and 109, the portion 108 that carries the rotor 106 being made of a material that is not magnetic, e.g. a non-magnetic stainless steel; and
a stator 110 carried by the main rod 2 and prevented from rotating by a key 111. The stator is made of a non-magnetic conductive material.

The rotor 106 and the stator 110 interact magnetically such that when the rotary bearing 102 and thus the rotor 106 rotate, an opposing electromagnetic torque is established that tends to brake the rotation of the rotary bearing 102, and thus to brake the extension of the auxiliary rod 20. These magnetic brake means are purely passive and they exert a braking force on the auxiliary rod 20 that is proportional to the speed of rotation of the rotary bearing 102, and thus to the speed at which the auxiliary rod 20 is being extended.

The brake means 117 thus act directly on the element (the rotary bearing) that is in helical connection with the auxiliary rod 20.

Naturally, other embodiments within the competence of the person skilled in the art could equally well be envisaged without thereby going beyond the ambit of the invention as defined by the following claims. For example, in one possible embodiment, the blocking member 116 could serve simultaneously to perform a blocking function and a braking function on the auxiliary rod 20. For this purpose, a blocking member could be provided that includes a disk brake suitable for providing proportional braking of the rotary bearing 102.

Furthermore, although the rotary bearing described is the end bearing of the main rod, which bearing is prevented from rotating in order to keep the auxiliary rod stationary in the main rod, it would naturally be possible, and in accordance with the invention, to use the same strategy to brake the rotary bearing 22 of the embodiment shown in FIG. 1, which bearing is not the end bearing of the main rod, but the end bearing of the auxiliary rod, and is helically associated with the main bearing.

What is claimed is:

1. A telescopic actuator comprising a cylinder receiving a main rod to slide along a sliding axis between a retracted position and an extended position, the actuator further including an auxiliary rod slidable in the main rod between a retracted position and an extended position, and a rotary bearing carried by the main rod or the auxiliary rod and co-operating respectively with the auxiliary rod or the main rod via a reversible helical connection such that sliding of the auxiliary rod causes the rotary bearing to rotate, wherein the actuator includes retaining means for retaining the sliding of the auxiliary rod and comprising a blocking member arranged to act directly on the rotary bearing so as to cause rotation of the rotary bearing to be blocked or to be released, blocking rotation of the rotary bearing preventing the auxiliary rod from moving in the main rod.

2. An actuator according to claim 1, wherein the retaining means further comprise brake means enabling rotation of the rotary bearing to be braked while the auxiliary rod is sliding in the extension direction.

3. An actuator according to claim 1, wherein the main rod carries the rotary bearing at its end, which bearing co-operates with the auxiliary rod via a reversible helical connection.

4. An actuator according to claim 1, wherein the blocking member comprises a brake of electromagnetic type.

5. An actuator according to claim 4, wherein the electromagnetic brake in its active mode blocks the rotary bearing, preventing the auxiliary rod from being extended.

6. An actuator according to claim 4, wherein the electromagnetic brake is of the single-disk type.
